(19) United States
(12) Patent Application Publication
(10) Pub. No.: US 2015/0322841 A1
(43) Pub. Date: Nov. 12, 2015

(54) Exhaust Line Comprising a Heat Exchanger, Corresponding Manufacturing Process and ...

(71) Applicant: Faurecia Systemes D'Echappement, Nanterre (FR)

(72) Inventor: Frederic Greber, Ecot (FR)

(21) Appl. No.: 14/703,926

(22) Filed: May 5, 2015

(30) Foreign Application Priority Data
May 7, 2014 (FR) 1454150

(51) Int. Cl. F01N 5/02; B23P 15/26; F02G 5/02

(52) U.S. Cl. CPC F01N 5/02; F02G 5/02; B23P 15/26

(57) ABSTRACT

An exhaust line includes a spiral heat exchanger having a first passage for a first fluid and a second passage for a second fluid. The second passage is arranged in a manner such that the second fluid circulates from an inlet firstly in at least one first circumferential segment disposed in a proximity of a first axial end and then into a plurality of second circumferential segments shifted towards a second axial end relative to the first circumferential segment. The second fluid advances axially in a counter current flow against the first fluid towards the first axial end while passing from one second circumferential segment to the next.

### RELATED APPLICATION

This application claims priority to FR 14 54150, filed May 7, 2014.

### TECHNICAL FIELD

The invention relates generally to spiral heat exchangers, in particular spiral heat exchangers designed to be interposed in an exhaust line of a vehicle.

### BACKGROUND

More specifically, according to a first aspect, the invention relates to a vehicle exhaust system comprising a spiral heat exchanger, the heat exchanger being of the type comprising a lower plate and an upper plate superposed on each other and wound in a spiral around a winding axis, the respective first large faces of the lower and upper plates together delimiting therebetween a first passage for circulation of a first fluid, the respective second large faces of the lower and upper plates opposite to the first large faces together delimiting therebetween a second passage for circulation of a second fluid. The first passage is laid out so that the first fluid axially circulates from a first axial end of the heat exchanger as far as a second axial end of the heat exchanger opposite to the first. The second passage is laid out so that the second fluid circulates from an inlet as far as an outlet. The second passage comprises a plurality of substantially circumferential segments fluidically connected together to each other and axially distributed along the heat exchanger. The first passage is fluidically connected to a conduit for circulation of the exhaust gases. The second passage is fluidically connected to a heat recovery circuit, preferably with a Rankine cycle.

Such a heat exchanger is known from the document FR 2 982 662. It is described as being interposed in an exhaust line. The exhaust gases constitute the first fluid, and flow axially from the first end of the heat exchanger going as far as the second end.

The heat exchanger functions as an evaporator. The second fluid at the inlet of the second passage is in the liquid state. It gets evaporated in the heat exchanger by the heat released by the exhaust gases. At the outlet of the second passage, the second fluid is in the superheated vapor state.

In the document FR 2 982 662, the inlet of the second passage is located in the proximity of the second axial end and the outlet in the proximity of the first axial end. The second fluid advances, from the outlet, axially against the current of the exhaust gases, passing from one circumferential segment to the next.

The temperature of the exhaust gas flowing to the first axial end of the heat exchanger varies considerably, depending on the engine speed. It has been found that it was difficult to control the temperature of the second fluid at the outlet of the second passage, when the exhaust gases attain considerably high temperatures.

Typically, an increase in the temperature of the exhaust gas is controlled by increasing the rate of flow of the second fluid in the interior of the heat exchanger. However, it is observed that a temperature runaway of the second fluid can come about very quickly, whereas the effect of an increase in the flow rate of the second fluid is quite significantly slower. Furthermore, such an increase in flow rate, when it is not well controlled, may well lead to flooding of the evaporator, in a manner such that the mole fraction of the steam at the outlet of the heat exchanger becomes less than 1.

### SUMMARY

In this context, the invention aims to provide an exhaust line system with a spiral heat exchanger in which the temperature of the second fluid at the outlet of the second passage is easier to control.

To this end, the invention concerns an exhaust line comprising a spiral heat exchanger of the aforementioned type, wherein the second passage is laid out in a manner such that the second fluid flows from the inlet firstly into at least one first circumferential segment disposed in the proximity of the first axial end, and then into a plurality of second circumferential segments shifted towards the second axial end relatively to the first circumferential segment, the second fluid advancing axially in a counter current flow against the first fluid towards the first axial end while passing from one second circumferential segment to the next.

Thus, the second fluid at the inlet of the heat exchanger circulates first in contact with the first fluid entering into the heat exchanger. The first fluid at this point presents a high temperature, which will come to be lowered considerably due to the heat transferred to the second fluid flowing in the first circumferential segment.

The second fluid, in the second circumferential segments, is in thermal contact with the first fluid, the latter being at a moderate temperature on account of the heat already transferred at the level of the first circumferential segment.

Due to the fact that the second fluid progresses axially in a counter current flow against the first fluid towards the first axial end while passing from one second circumferential segment to the next, the rise in temperature of the second fluid is rapid upon switching on the heat exchanger. It is in particular considerably faster than if the second fluid were to advance in a co-current flow relative to the first fluid while passing from one second circumferential segment to the next.

However, the temperature runaway phenomena of the second fluid are avoided at the outlet of the second passage, in case of a sudden increase in the temperature of the first fluid at the inlet of the heat exchanger.

Indeed, the fact that the first fluid flows initially in contact with the first circumferential segment, wherein the second fluid is found to be at its coldest, has the effect that the sudden increase in the temperature of the first fluid is considerably reduced when the first fluid comes in contact with zones of the second passage where the second fluid is at its hottest. Such zones are for example formed by the second circumferential segments that are closest to the first end.

In the absence of the first circumferential segment, the first fluid entering into the heat exchanger at its maximum temperature, would exchange directly with the last second circumferential segments, containing the second fluid at its highest temperature. A sudden increase in the temperature of the first fluid would therefore have a direct impact on the temperature of the second fluid exiting the second passage.

Thus, in the invention, it is possible to obtain a very robust production of the second fluid, in the sense that it is easier to maintain the temperature of the second fluid at the outlet of the heat exchanger within a narrow temperature range, even when the flow rate and/or the temperature of the first fluid varies greatly at the inlet of the heat exchanger.

It is to be noted that the effect of an increase in the flow rate of the second fluid, for example to compensate for a sudden increase in the temperature of the first fluid at the inlet of the heat exchanger, is very rapid. Indeed, the impact of this increase in flow rate becomes evident immediately in the first circumferential segment, which is exposed to the first fluid entering into the heat exchanger.

The heat exchanger of the invention therefore allows for rapidly reducing the temperature of the first fluid entering into the heat exchanger, while also maintaining a sufficient temperature gradient between the first fluid and the second fluid due to the fact that the second fluid advances in a counter current flow from one second circumferential segment to another.

The exhaust line may also have one or more of the following features, taken into consideration individually or in accordance with all technically possible combinations:
the second fluid flows from the inlet firstly in a plurality of first circumferential segments disposed in the proximity of the first axial end, the second fluid advancing axially in a co current flow relative to the first fluid, to the second axial end while passing from one first circumferential segment to the next;
the inlet and the outlet are located in the proximity of the first axial end;
the inlet opens directly into the circumferential segment that is situated closest to the first axial end;
the spiral includes a plurality of turns, the second passage including a plurality of third circumferential segments fluidically connected together therebetween and placed downstream from the second circumferential segments, the third circumferential segments being disposed in the radially externalmost turn of the spiral;
the second fluid advances axially in a co-current flow relative to the first fluid to the second axial end while passing from one third circumferential segment to the next; and
the upper and/or lower plates include recessed areas defining at least the circumferential segments of the second passage.

According to a second aspect, the invention relates to a manufacturing method for manufacturing an exhaust line having the features indicated here above, the method comprising the following steps:
forming and shaping the lower and upper plates in a manner to obtain the recessed areas;
superposing the lower and upper plates in a manner such that the recessed areas define at least the circumferential segments of the second passage;
welding or brazing/soldering the lower and upper plates to each other in such a way as to separate the circumferential segments of the second passage from each other in a sealed manner;
winding the lower and upper plates in a spiral.

In accordance with a third aspect, the invention relates to a method for operating an exhaust line having the above noted features, the method comprising the following steps:
causing the circulating of the first fluid in the first passage from the first axial end towards the second axial end of the heat exchanger;
causing the circulating of the second fluid in the second passage, the first fluid being in the liquid state at the inlet of the second passage, the second fluid being vaporised in the heat exchanger and flowing out through the outlet in the vapor state.

### BRIEF DESCRIPTION OF THE DRAWINGS

Other characteristic features and advantages of the invention will become apparent from the detailed description which is provided here below, for illustrative purposes only and without any limitation, with reference being made to the accompanying drawings, in which:

FIG. 1 is a perspective view of a heat exchanger according to the invention;

FIG. 2 is an axial view of the heat exchanger shown in FIG. 1, with the internal tube and the external envelope thereof;

FIG. 3 is a perspective view of the lower and upper plates of the heat exchanger of the invention, prior to assembly;

FIG. 4 is a view from above of the lower and upper plates of the heat exchanger, in the unwound state;

FIG. 5 is a view similar to that shown in FIG. 4, for a first variant embodiment of the invention;

FIG. 6 is a view similar to that shown in FIG. 4, for a second variant embodiment of the invention; and

FIG. 7 is a partial view of an exhaust line incorporating the heat exchanger shown in FIG. 1.

### DETAILED DESCRIPTION

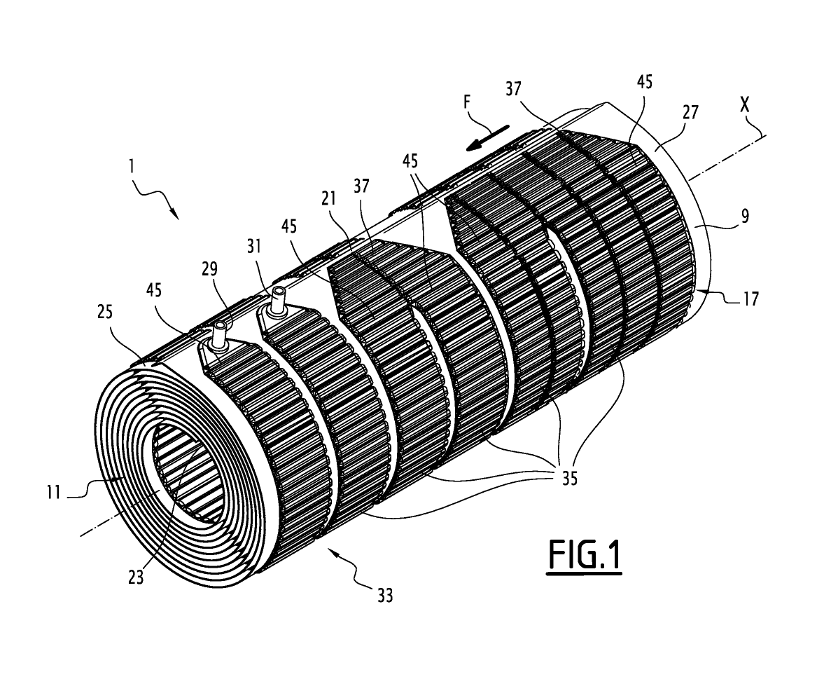

The heat exchanger shown in FIG. 1 is an evaporator, designed to be inserted in an exhaust line of the vehicle.

However, it is possible for this heat exchanger to not be an evaporator, and be a simple heat exchanger between two fluids, the fluids not undergoing a change in state.

The vehicle is typically a motor vehicle, for example a car or a truck.

By way of a variant, the heat exchanger may be used in any type of industrial facility, in air conditioning systems or for any other suitable application.

As is shown in FIGS. 1 to 3, the spiral heat exchanger 1 comprises a lower plate 3 and an upper plate 5 superposed on each other and wound in a spiral around a winding axis X, the respective first large faces 7, 9 of the lower and upper plates together delimiting therebetween a first passage 11 for circulation of a first fluid, the respective second large faces 13, 15 of the lower and upper plates opposite to the first large faces 7, 9 together delimiting therebetween a second passage for circulation 17 of a second fluid.

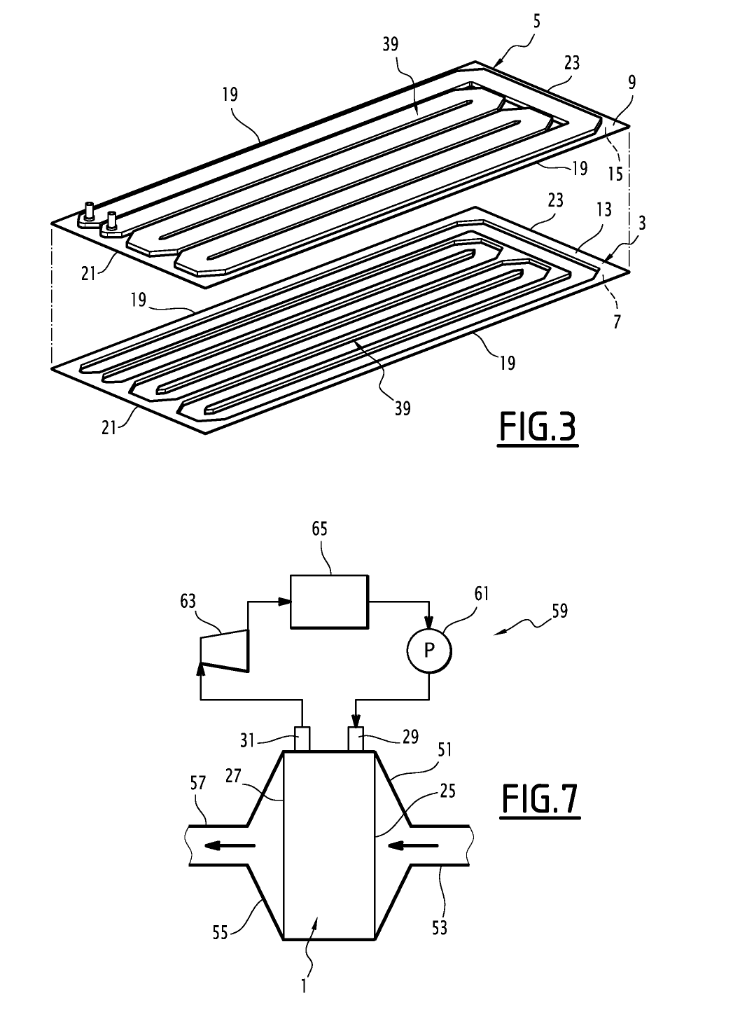

The lower and upper plates 3, 5 are shown in FIG. 3. They typically have a rectangular shaped form, in the expanded open state. They are each bounded by two lateral edges 19 that are parallel to each other, an external transverse edge 21, and an internal transverse edge 23. The internal and external transverse edges 21, 23 are parallel to one another and are also parallel to the winding axis. In the wound state, the external transverse edge 21 is located radially on the exterior of the heat exchanger, and the transverse edge 23 is located radially in the interior of the exchanger. The edges 19 are wound in a spiral around the winding axis.

In the example represented, the edges 19, 21, 23 are straight. By way of a variant, the plates are not rectangular and have any other form suitable, the edges are not necessarily straight.

The lower plate 3 and the upper plate 5 are superposed in a manner such that, in the expanded open state, the second large faces 13, 15 are positioned to be facing each other.

The lower and upper plates 3 and 5, once they are wound, form a plurality of turns around the winding axis X. The lower and upper plates 3 and 5 of the same coil define therebetween one turn of the second passage 17. In contrast, the first passage 11 is defined between the lower plate 3 of the said turn and the upper plate 5 of the radially lower turn.

The first passage 11 is arranged in order for the first fluid to flow axially from a first axial end 25 of the heat exchanger right up to a second axial end 27 of the heat exchanger that is opposite the first.

The first and second axial ends 25, 27 of the heat exchanger are defined by the lateral edges 19 of the plates.

In the example shown, the first passage 11 is open at both the axial ends 25, 27. More precisely, the lateral edge 19 of the lower plate 3, at the level of a given turn, is separated from the lateral edge 19 of the upper plate 5 situated at the next lower turn.

The situation is the same with the second axial end. The edge 19 of a given turn of the lower plate 3 is separated from the edge 19 of the upper plate 5 situated at the next lower turn.

The edges 19 of the plates 3 and 5 therefore define at the first end 25, an interstice in the spiral constituting the inlet for the first fluid. The edges 19 of the lower and upper plates 3 and 5 also define at the second end 27, an interstice in the spiral constituting the outlet for the first fluid.

The first fluid passes through the heat exchanger 1 following a substantially axial flow pattern, from said inlet up until the said outlet.

By way of a variant, the flow of the first fluid is not strictly axially but may be both axial and circumferential. According to another variant, the first passage may comprise segments that are axial and/or inclined relative to the axis of winding, and the circumferential segments.

The second passage is arranged in a manner such that the second fluid flows from an inlet 29 for the second fluid to an outlet 31 for the second fluid, the second passage 17 comprising a plurality of substantially circumferential segments 33, 35 connected fluidically to each other and distributed axially along the heat exchanger 1.

The circumferential segments 33, 35 are connected to each other by connecting segments 37, 38.

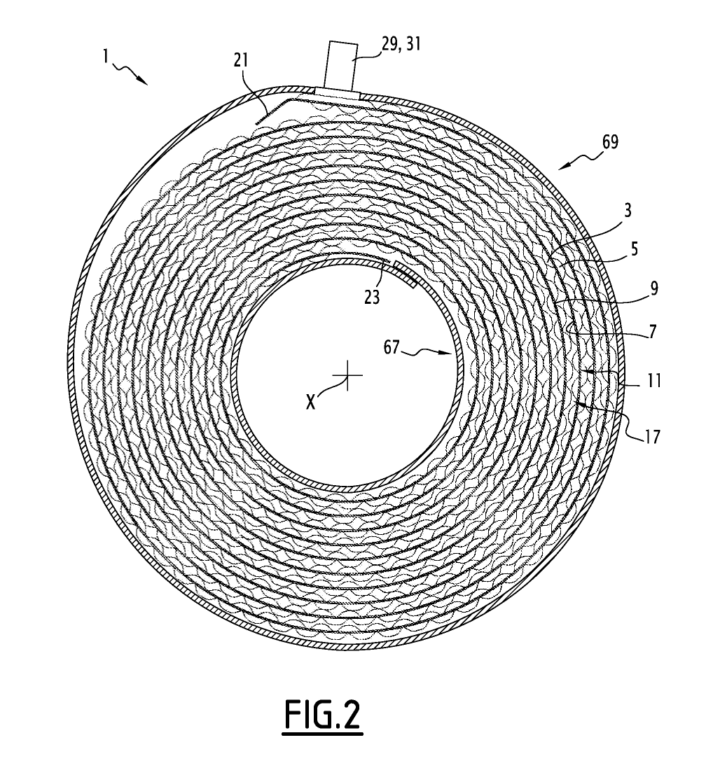

As shown in FIGS. 1 and 2, in the opened state, the circumferential segments 33, 35 extend substantially parallel to the lateral edges 19.

In the wound state, the circumferential segments 33, 35 extend spirally around the winding axis X. They are substantially parallel to each other.

By way of a variant, the circumferential segments are not strictly circumferential. Some or all of these segments may, in the opened state, be inclined relative to the lateral edges 19. The segments 33, 35 may also comprise short segments that are parallel to the winding axis.

In the example represented in the figures, the upper and/or lower plates 3, 5 comprise recessed areas 39 (FIG. 3) defining at least the circumferential segments 33, 35 of the second passage. Typically, the recessed areas 39 also define the connecting segments 37, 38.

The recessed areas 39 are concave towards the respective second large faces 13, 15, and convex towards the first large faces 7, 9. Typically, these recessed areas are obtained by stamping or by any other suitable process that enables the shaping and forming of the lower and upper plates.

The recessed areas 39 of the two plates are superposed with each other in a manner so as to define the path of the second passage 17. The recessed areas 39 of the lower and upper plates 3, 5 are, for example symmetrical with each other relative to the plane of contact between the two plates. By way of a variant, they are not exactly symmetrical, as is described for example in the document FR 2 982 662.

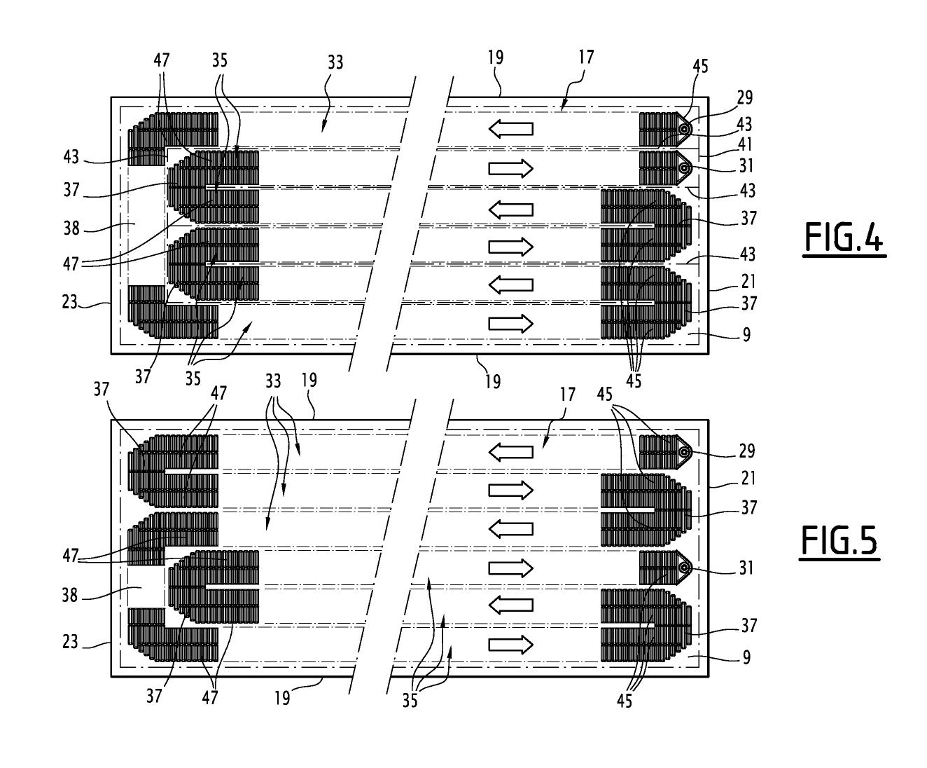

The lower and upper plates 3, 5 are welded to one another along sealed weld seams 41, 43, represented in FIG. 4. The seam 41 is a peripheral weld seam, that integrally secures to one another the respective peripheral edges of the lower and upper plates 3, 5. The weld seams 43 separate the various different segments of the second passage from each other, in such a way that the circumferential segments communicate with each other only by the connecting segments 37, 38. More specifically, each segment 33, 35, 37, 38 is flanked by two continuous weld seams.

The lower and upper plates 3, 5 are in contact with each other across all the surfaces that are not part of the recessed areas 39.

By way of a variant, only one of the lower and upper plates has a recessed area 39 defining the circumferential segments and/or the connecting segments of the second passage.

According to another variant embodiment, the upper and/or lower plates do not have recessed areas, the circumferential segments and/or connecting segments of the second passage being defined by rods placed between the second large faces of the lower and upper plates and welded in a sealed manner to this large face.

It is to be noted that the spacing between the first large faces of the lower and upper plates is maintained by any suitable means, in a manner to ensure a sufficient flow channel area for the first fluid. For example, spacers, struts, or fins are fitted between the first large surfaces.

The circumferential segments 33, 35 are typically uniformly distributed axially along the heat exchanger 1. By way of a variant, the axial spacing between the circumferential segments is not constant. This can be advantageous in particular when the heat exchanger is an evaporator, the circumferential segments within which the steam circulates being axially wider and therefore spaced further apart from each other than those within which the liquid flows.

The second passage 17 is laid out in a manner such that the second fluid flows from the inlet 29 firstly in at least one first circumferential segment 33 disposed in the proximity of the first axial end 25 of the heat exchanger, and then into a plurality of second circumferential segments 35 shifted towards the second axial end 27 relative to the first circumferential segment, the second fluid advancing axially in a counter current flow against the first fluid towards the first axial end while passing from one second circumferential segment 35 to the next.

The expression ‘advancing axially in a counter current flow against the first fluid’ here refers to the fact that the connecting segments 37, 38 are arranged so that the second fluid, after having passed through a given second circumferential segment 35, passes into another second circumferential segment 35 positioned closer to the first end. The second fluid thus has a path that is both circumferential in a spiral around the winding axis X, and axial, going from the second end 27 towards the first end 25 of the heat exchanger.

According to the embodiment shown in FIGS. 1 to 4, the heat exchanger comprises one single first circumferential segment 33, located at the first axial end 25.

As may be seen in FIG. 4, each circumferential segment 33, 35 has an external end 45 and an internal end 47. The external end 45 is situated relatively closer to the external transverse edge 21, and the radially internal end 47 is situated relatively closer to the internal transverse edge 23. Thus, after winding, the end 45 is situated towards the exterior of the heat exchanger and the end 47 towards the interior of the heat exchanger.

The inlet for the second fluid 29 opens directly into the external end 45 of the first circumferential segment 33.

The second passage 17 includes a plurality of second circumferential segments 35 extending from the second axial end 27 of the heat exchanger up to the first circumferential segment 33. The outlet 31 opens directly into the external end 45 of the second circumferential segment 35 situated immediately next to the first circumferential segment 33.

The second passage includes a connecting segment 38 extending along the internal transverse edge 23. This connecting passage 38 connects the internal end 47 of the first circumferential segment 33 to the internal end 47 of the second circumferential segment 35 which is situated closest to the second end 27.

Furthermore, as may be seen in FIG. 4, the second fluid flows along the second segments circumferentially 35 alternately from the interior towards the exterior and from the exterior towards the interior.

In order to develop such a circulation, each second circumferential segment 35 is connected via a connecting segment 37 by one of its internal or external ends to the preceding second circumferential segment 35 and, via another connecting segment 37 by the other of its internal or external ends to the subsequent circumferential segment 35.

Thus, the circumferential segments 35 are alternately connected in two different ways. Some are connected by their internal ends 47 to the internal end of the preceding circumferential segment, and by their external ends 45 to the external end 45 of the subsequent segment.

Others, conversely, are connected by their external ends to the external end of the preceding segment 35, and by their internal ends to the internal end of the subsequent segment 35. The terms preceding and subsequent are used here in relation to the direction of flow of the second fluid.

A first variant embodiment of the invention will now be described, with reference being made to FIG. 5. Only the points by which the first variant embodiment differs from that of FIGS. 1 to 4 shall be detailed here below. Elements that are identical or serve the same function shall be denoted by the same reference indicators.

According to the first variant, the second passage 17 includes a plurality of first circumferential segments 33. In FIG. 5, the second passage 17 includes three first circumferential segments 33. Alternatively, the second passage 17 includes a different number of first circumferential segments 33. This is generally an odd number, but it may be even.

The first circumferential segments 33 are arranged axially one beside the other, one of the first segments 33 being disposed at the first axial end 25. Thus, all of the second circumferential segments 35 are shifted towards the second end 27 relative to the first segment 33.

The second fluid flows through the first circumferential segments 33 alternately from the exterior towards the interior and from the interior towards the exterior.

The inlet 29 opens directly into the external end 45 of the first circumferential segment situated the closest to the end 25 of the exchanger. The internal end 47 of this first circumferential segment is connected to the internal end 47 of the subsequent circumferential segment, by a connecting segment 37. The external end 45 of this first circumferential segment is connected by another connecting segment 37 to the external end 45 of the subsequent segment, and so on. The internal end of the last first circumferential segment 33 is connected by the connecting conduit 38 to the second circumferential segment situated the closest to the second end 27.

The outlet for the second fluid 31 opens directly into the external end 45 of the second circumferential segment situated next to the first circumferential segments 33.

Such an arrangement offers the advantage of making it possible to significantly lower the temperature of the first fluid at the inlet of the exchanger. It is appropriately adapted for operation with a particularly hot first fluid.

It is to be noted that the second fluid advances axially in a co-current flow relative to the first fluid, to the second axial end while passing from one first circumferential segment to the next.

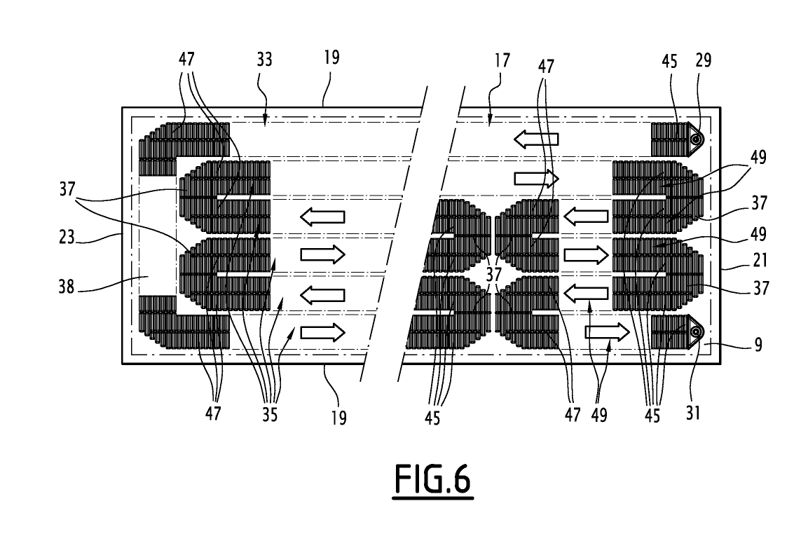

A second variant embodiment will now be described, with reference to FIG. 6. Only the points by which this second embodiment differs from that represented in the FIGS. 1 to 4 shall be detailed here below. Elements that are identical or serve the same function shall be denoted by the same reference indicators.

In the variant embodiment of FIG. 6, the second passage 17 includes, in addition to the first circumferential segments 33 and in addition to the second circumferential segment or segments 35, a plurality of third circumferential segments 49 fluidically connected to each other and placed downstream from the second circumferential segments 35. The third circumferential segments 49 are arranged in the radially external most turn of the spiral.

As may be seen in FIG. 6, the third circumferential segments 49 are also axially shifted towards the second axial end 27 relative to the first circumferential segment 33.

Typically, they extend only along the last turn, but not along the other turns. By way of a variant, they extend not only over the last turn but extend circumferentially over one or more lower turns.

The third circumferential segments 49 extend axially over the same portion of the heat exchanger as the second circumferential segments 35. In contrast, the third circumferential segments 49 are arranged in the turn or turns that are radially external most, while the second circumferential segments 35 are disposed in the internal most turns.

In FIG. 6, it may be seen that the third circumferential segments 49 are arranged along the external transverse edge 21. The second circumferential segments 35 are situated between the internal transverse edge 23 and the third circumferential segments 49.

The third circumferential segments 49 are parallel to each other and extend from the axial end 27 up to the first circumferential segment 33.

The second passage 17 is arranged in a manner such that the second fluid flows in the third circumferential segments 49, alternately circumferentially from the interior towards the exterior, and circumferentially from the exterior towards the interior. The segments 49 are thus alternately connected in two different ways. Some segments are connected by their respective internal circumferential ends 47 to the subsequent segment 49, and by their respective external circumferential ends 45 to the preceding segment. Others, conversely, are connected by their respective internal circumferential ends 47 to the preceding segment 49 and by their respective external circumferential ends 45 to the subsequent segment 49.

The outlet 31 communicates directly with the external end 45 of the third circumferential segment 49 that is situated closest to the axial end 27 of the exchanger. The internal end 47 of the third circumferential segment 49 that is situated closest to the first axial end 25 communicates with the external end 45 of the second circumferential segment 35 situated closest to the first axial end 25.

Thus, the second fluid advances axially in a co-current flow relative to the first fluid, to the second axial end 27 while passing from one third circumferential segment 49 to the next.

Such an arrangement contributes to preventing overheating of the second fluid. Indeed, the third circumferential segments 49 contain the hottest portion of the second fluid. In particular, when the heat exchanger functions as an evaporator, the third turns 49 contain the superheated steam. Due to the fact that these third segments are accommodated in the external most turn, they are cooled to a greater extent than the circumferential segments disposed in the radially internal most turns.

The heat exchanger 1 is, for example, used in an exhaust line, as illustrated in FIG. 7. The first circulation passage 11 is fluidically connected to a conduit for circulation of the exhaust gas. The second passage 17 is interposed in a heat recovery circuit 59 in which a heat transfer fluid circulates. The heat exchanger 1 functions as an evaporator.

More precisely, a divergent segment 51 connects the first axial end 25 of the heat exchanger to a conduit 53 for exhaust gas supply. This conduit 53 is connected to a manifold (not shown), which captures the exhaust gas exiting from the combustion chambers of the engine. A convergent segment 55 connects the second axial end 27 of the heat exchanger to a conduit 57 for discharging the exhaust gas. The conduit 57 is connected to a cannula for releasing exhaust gases into the atmosphere (not shown) with interposition of one or more exhaust gas purification members. The divergent segment 51 internally delimits a volume which communicates with the first passage 11 and distributes the exhaust gas in this first passage. The convergent 55 captures the exhaust gas exiting from the first passage.

The heat recovery circuit 59 is typically a Rankine cycle. This circuit 59 comprises a circulation unit such as a pump 61, which forces the second fluid towards the inlet 29. It also includes an expansion member 63, for example a turbine, in which the steam exiting out of the heat exchanger 1 through the outlet 31 is expanded to a low pressure. The circuit 59 further includes a condenser 65, interposed between the outlet of the expansion member 63 and the suction port of the pump 61.

The operating method for operating the exhaust line will now be detailed, when the heat exchanger is operating as an evaporator.

This method includes among others the following steps:
causing the circulating of the first fluid in the first passage 11, from the first axial end 25 towards the second axial end 27 of the heat exchanger 1;
causing the circulating of the second fluid in the second passage 17, the first fluid being in the liquid state at the inlet 29 of the second passage, the second fluid being vaporised in the heat exchanger and flowing out through the outlet 31 in the vapor, in particular in the superheated vapor state.

The first fluid is firstly in contact with the one or more first circumferential segments 33 of the second passage, in a manner such that its temperature is lowered upon entry of the first fluid in the heat exchanger.

Then, the first fluid is brought into thermal contact with the second fluid, this second fluid advancing axially in a counter current flow against the first fluid as it passes from one second circumferential passage 35 to the next. The second fluid is vaporised in the second circumferential segments 35, and is presented in particular in the second circumferential segment or segments 35 situated the closest to the first circumferential segments 33 in the form of a superheated vapor.

The manufacturing method for manufacturing an exhaust line according to the invention will now be detailed.

The method comprises the following steps, developed for the manufacture of the spiral heat exchanger:
forming and shaping the lower and/or upper plates 3, 5 in a manner so as to obtain the recessed areas 39;
superposing the lower and upper plates 3, 5 in a manner such that the recessed areas 39 define at least the circumferential segments 33, 35,49 of the second passage 17;
welding or brazing/soldering the lower and upper plates 3, 5 to each other in such a way as to separate the circumferential segments 33, 35, 49 of the second passage from each other in a sealed manner;
winding the lower and upper plates 3, 5 in a spiral.

The step of forming and shaping is carried out by stamping or by any other suitable process. As previously indicated above, in an alternative embodiment, only one of the lower and upper plates is formed and shaped. By way of a variant, the two plates are formed and shaped.

Typically, the recessed areas define not only the circumferential segments 33, 35, 49 of the second passage, but also the connecting segments 37, 38. During the welding or brazing/soldering step, the lower and upper plates 3, 5 are integrally joined to one another along the seams 41 and 43 represented in FIG. 4. The seam 41 is a circumferential line along which the peripheral edges of the two plates are tightly welded or soldered to one another in a sealed manner. The seams 43 make it possible to separate the circumferential segments and the connecting segments from each other, in such a manner that each segment is adjoined by two rows of brazing/soldering or welding 41, 43.

It is to be noted that the plates are typically wound around a central tube 67, as illustrated in FIG. 2.

Furthermore, the method typically includes a step in which, after winding, the spiral coil is inserted in the interior of an external casing envelope 69, represented in FIG. 2. Only the inlet 29 and the outlet 31 project radially outside of the external casing envelope 69. This external casing envelope only covers the radially external surface of the spiral.

The first fluid is, for instance, the exhaust gases of a motor vehicle. By way of a variant, the first fluid may be any fluid, liquid or gaseous. The second fluid is, for example, water, or any other heat transfer fluid such as a water/ethanol mixture, a refrigerant fluid type such as R134 or R245fa or any other type of organic fluid compatible with a Rankine cycle or with any other cycle.

Several types of arrangement have been described here above for the second passage. However, it is possible to arrange the second passage in multiple ways, in accordance with the needs, particularly by varying the number of first circumferential segments and the number of second circumferential segments. These arrangements can be obtained in a spiral heat exchanger only on account of the fact that the upper and lower plates are welded or soldered to one another prior to winding. The welding or brazing/soldering operation in effect makes it possible to define the path of the second fluid. It is not possible to carry out this welding or brazing/soldering after the winding.

Although an embodiment of this invention has been disclosed, a worker of ordinary skill in this art would recognize that certain modifications would come within the scope of this disclosure. For that reason, the following claims should be studied to determine the true scope and content of this disclosure.

1. A vehicle exhaust line comprising a spiral heat exchanger, the heat exchanger comprising a lower plate and an upper plate superposed on each other and wound as a spiral around a winding axis, first respective large faces of the lower and upper plates delimiting together a first passage for circulation of a first fluid, second respective large faces of the lower and upper plates opposite to the first large faces delimiting together a second passage for circulation of a second fluid,
the first passage being laid out so that the first fluid axially circulates from a first axial end of the heat exchanger as far as a second axial end of the heat exchanger opposite to the first axial end;
the second passage being laid out so that the second fluid circulates from an inlet as far as an outlet, the second passage comprising a plurality of substantially circumferential segments fluidically connected together and axially distributed along the heat exchanger,
the first passage being fluidically connected to a conduit for circulation of exhaust gases, the second passage being fluidically connected to a heat recovery circuit,
wherein the second passage is laid out so that the second fluid circulates from the inlet first in at least one first circumferential segment placed in proximity to the first axial end, and then in a plurality of second circumferential segments shifted towards the second axial end relatively to the first circumferential segment, the second fluid axially making progress as a counter flow against the first fluid towards the first axial end by passing from one second circumferential segment to the next.

2. The exhaust line according to claim 1, wherein the second fluid circulates from the inlet first in a plurality of first circumferential segments placed in proximity to the first axial end, the second fluid axially making progress as a counter flow against the first fluid towards the second axial end by passing from one first circumferential segment to the next.

3. The exhaust line according to claim 1, wherein the inlet and the outlet are located in proximity to the first axial end.

4. The exhaust line according to claim 1, wherein the inlet directly opens into a closest circumferential segment to the first axial end.

5. The exhaust line according to claim 1, wherein the spiral includes a plurality of turns, the second passage including a plurality of third circumferential segments fluidically connected together and placed downstream from the second circumferential segments, the third circumferential segments being placed in a radially outermost turn of the spiral.

6. The exhaust line according to claim 5, wherein the second fluid axially makes progress as a counter flow against the first fluid towards the second axial end by passing from one third circumferential segment to the next.

7. The exhaust line according to claim 1, wherein at least one of the upper and lower plates include recessed areas at least defining the circumferential segments of the second passage.

8. A method for manufacturing an exhaust line comprising a spiral heat exchanger, the heat exchanger comprising a lower plate and an upper plate superposed on each other and wound as a spiral around a winding axis, first respective large faces of the lower and upper plates delimiting together a first passage for circulation of a first fluid, second respective large faces of the lower and upper plates opposite to the first large faces delimiting together a second passage for circulation of a second fluid, the first passage being laid out so that the first fluid axially circulates from a first axial end of the heat exchanger as far as a second axial end of the heat exchanger opposite to the first axial end, the second passage being laid out so that the second fluid circulates from an inlet as far as an outlet, the second passage comprising a plurality of substantially circumferential segments fluidically connected together and axially distributed along the heat exchanger, the first passage being fluidically connected to a conduit for circulation of exhaust gases, the second passage being fluidically connected to a heat recovery circuit, wherein the second passage is laid out so that the second fluid circulates from the inlet first in at least one first circumferential segment placed in proximity to the first axial end, and then in a plurality of second circumferential segments shifted towards the second axial end relatively to the first circumferential segment, the second fluid axially making progress as a counter flow against the first fluid towards the first axial end by passing from one second circumferential segment to the next, the method comprising the following steps for manufacturing the heat exchanger:
shaping the upper and lower plates to obtain recessed areas;
superimposing the lower and upper plates so that the recessed areas define at least the circumferential segments of the second passage;
welding or brazing the upper and lower plates to each other to separate the circumferential segments of the second passage, sealably from each other; and
winding the upper and lower plates to form the spiral.

9. A method for operating an exhaust line comprising a spiral heat exchanger, the heat exchanger comprising a lower plate and an upper plate superposed on each other and wound as a spiral around a winding axis, first respective large faces of the lower and upper plates delimiting together a first passage for circulation of a first fluid, second respective large faces of the lower and upper plates opposite to the first large faces delimiting together a second passage for circulation of a second fluid, the first passage being laid out so that the first fluid axially circulates from a first axial end of the heat exchanger as far as a second axial end of the heat exchanger opposite to the first axial end, the second passage being laid out so that the second fluid circulates from an inlet as far as an outlet, the second passage comprising a plurality of substantially circumferential segments fluidically connected together and axially distributed along the heat exchanger, the first passage being fluidically connected to a conduit for circulation of exhaust gases, the second passage being fluidically connected to a heat recovery circuit, wherein the second passage is laid out so that the second fluid circulates from the inlet first in at least one first circumferential segment placed in proximity to the first axial end, and then in a plurality of second circumferential segments shifted towards the second axial end relatively to the first circumferential segment, the second fluid axially making progress as a counter flow against the first fluid towards the first axial end by passing from one second circumferential segment to the next, the method comprising the following steps:
having the first fluid circulate in the first passage of the first axial end towards the second axial end of the heat exchanger;
having the second fluid circulate in the second passage, the first fluid being in a liquid state at the inlet of the second passage, the second fluid being vaporized in the heat exchanger and flowing out through the outlet in a vapor state.

10. The exhaust line according to claim 1, wherein the heat exchanger includes a heat recovery circuit that is a Rankine cycle.
